(19) United States
(12) Patent Application Publication
(10) Pub. No.: US 2019/0102742 A1
(43) Pub. Date: Apr. 4, 2019

(54) DIVERSITY IMPACT MONITORING TECHNIQUES

(71) Applicant: Oracle International Corporation, Redwood Shores, CA (US)

(72) Inventors: Vikas Agrawal, Hyderabad (IN); Saurav Mohapatra, Hyderabad (IN); Anirban Majumdar, Hyderabad (IN); Ispati Nautiyal, Bangalore (IN); Manisha Gupta, San Ramon, CA (US)

(73) Assignee: Oracle International Corporation, Redwood Shores, CA (US)

(21) Appl. No.: 16/140,153

(22) Filed: Sep. 24, 2018

(30) Foreign Application Priority Data
Sep. 29, 2017 (IN) 201741034647

(51) Int. Cl. G06Q 10/10; G06F 17/18; G06F 15/18; G06F 17/30

(52) U.S. Cl. CPC G06Q 10/1053; G06F 17/30707; G06F 15/18; G06F 17/18

(57) ABSTRACT

There are significant advantages to employing a diverse workforce within an enterprise. Techniques for identifying gaps in diversity hiring, promotion, and termination within an enterprise are provided herein. The techniques described herein may be used to analyze any large data set for comparison of aggregated data. Employment data may be collected and aggregated based on classifications such as ethnicity, gender, veteran status, disability status, and so forth, and within each classification the data can be aggregated for hiring, termination, promotion, and so forth. Two aggregates can be identified for comparison, and statistical scores may be generated for the first aggregate as compared to the second aggregate. Each of the statistical scores may be weighted and the scores may be combined to generate a single impact score. The impact score can be used to identify gaps in diversity employment practices within the enterprise.

### CROSS-REFERENCES TO RELATED APPLICATIONS

This Application claims priority under 35 U.S.C. § 119 to India Provisional Patent Application number 201741034647, filed Sep. 29, 2017, entitled “SYSTEMS AND METHODS FOR AUTOMATIC ONLINE DETECTION, MONITORING, AND SELF-AUDIT OF DIVERSITY ADVERSE IMPACT RISK,” which is incorporated herein in its entirety for all purposes.

### BACKGROUND

There are many benefits to employing a diverse workforce. Diversity in the workplace may improve problem solving, decision making, innovation, and creativity. Further, companies with a diverse workforce may have a competitive edge because they may be better positioned to attract the best talent. Additionally, a diverse workforce may be better able to serve the needs of diverse clients to improve company performance. Federal regulations may also require certain diversity goals and punish discrimination. For example, in the United States, employers may not discriminate against employees or candidates that are members of protected classes. Discrimination in hiring, termination, and compensation may lead to federal charges, civil law suits, poor employee and business performance, and low employee morale, among other issues. However, particularly for large corporations employing hundreds of employees, the amount of related data may be so large that it may be difficult for the management of the corporation to analyze the data to know whether any of the representatives are engaging in discriminatory practices. The information for hiring, compensation, and termination with respect to employee data may not be easily identified. Even once the information is obtained, which can take months, processing the information in any meaningful way is complex and time consuming. Current systems that may have some of the information, simply provide long laundry lists of computations with no prioritization of information to allow a user to meaningfully analyze diversity related employment issues.

### BRIEF SUMMARY

The present disclosure relates generally to monitoring and analysis of large data sets. More particularly, data analysis techniques are described as applied to diversity monitoring in employment, hiring, and promotion practices. In certain embodiments, analysis techniques are described for analyzing employment, hiring, and promotion information to generate analysis results (e.g., diversity statistics) that indicate whether there are employment gaps related to diversity and a diverse workforce within an enterprise. Various inventive embodiments are described herein, including methods, systems, non-transitory computer-readable storage media storing programs, code, or instructions executable by one or more processors, and the like.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for monitoring diversity impact. The method may include receiving employment information for an enterprise from multiple data sources. The employment information may include employee data for employees of the enterprise. The method may include generating aggregates of the employment information based on classifications. The method may also include identifying a first aggregate to analyze. The method may further include identifying a second aggregate related to the first aggregate for identifying an impact score. The method may also include generating multiple statistical scores for the first aggregate as compared to the second aggregate, where each statistical score is based on a statistical model. The method may also include assigning a weight to each of the statistical scores to generate weighted statistical scores, where the weighting each of the statistical scores is based at least in part on attributes of the employment information used to generate the first aggregate and the second aggregate and based at least in part on a value of each of the statistical scores. The method may also include computing an impact score for the first aggregate as compared to the second aggregate by combining the weighted statistical scores. The method may also include transmitting the impact score to a user device for output by the user device. Other embodiments of this aspect include corresponding computer systems, apparatus, and computer programs recorded on one or more computer storage devices, each configured to perform the actions of the methods.

Implementations may include one or more of the following features. Optionally, assigning a weight to each statistical score to generate weighted statistical scores may include identifying the size of the data set of the employment information used to generate the first aggregate and the second aggregate. Optionally, assigning weights to statistical scores to generate the weighted statistical scores may further include setting the weight for at least one of the statistical scores based on an accuracy or applicability of the statistical model used to generate the statistical score for the size of the data set that has the smallest possible deviation from the individual scores.

The method may optionally include performing a linear regression or a more complex continuous predictor machine learning technique to combine the weighted statistical scores. Optionally the statistical models include at least one of Pearson's Chi-square test, two tailed z-test, or Fisher's Exact Test. Optionally, the classifications include at least one of gender, ethnicity, veteran status, disability status, or age. Optionally, each of the aggregates provides an aggregate value based on a classification aggregated over a period of time by an employment data type. Optionally, the employment data type may be one of compensation, hiring, termination, and promotion.

Optionally, the method further includes, in response to receiving the employment information of the enterprise from the data sources, converting the employment information from each of the data sources to a single format. The method may also include storing the converted employment information in a diversity impact data store. Optionally, the aggregates are generated from the converted employment information.

Optionally, the employment information includes at least one of enterprise hiring data, enterprise termination data, enterprise compensation data, or enterprise promotion data. Optionally, the employee data for employees of the enterprise includes, for each employee, at least one of gender, ethnicity, veteran status, disability status, and age. Optionally, transmitting the impact score to the user device includes determining that the impact score exceeds a threshold value and transmitting an alert to the user device including a natural language message including the impact score. Optionally, transmitting the impact score to the user device includes generating a graphical user interface including an image of a geographical region with an indicator of the impact score. Optionally, clicking on the indicator provides drill-down capabilities that expose the first aggregate, the second aggregate, and the employment information used to generate the first diversity aggregate and the second diversity aggregate.

The method may also include generating impact scores each based on one of the aggregates. Optionally, the impact scores are ranked based at least in part on a size of a data set of the employment information used to generate the aggregate on which the impact score is based. Optionally, the impact scores are ranked based at least in part on statistics from an external source. Optionally, the external source is the United States Department of Labor. Implementations of the described techniques may include hardware, a method or process, or computer software on a computer-accessible medium.

In some alternative embodiments, one general aspect includes a system for monitoring diversity impact. The system may include one or more processors and a memory storing instructions that may be executed by the one or more processors to provide a graphical user interface to a user including a selection menu. The instructions may also cause the processors to receive, from the graphical user interface, a selection of a classification, a time frame, and an employment data type. The instructions may also cause the processors to obtain first employment data having the selected classification, the selected time frame, and the selected employment data type. The instructions may also cause the processors to identify a comparable classification to the selected classification. The instructions may also cause the processors to obtain second employment data having the comparable classification, the selected time frame, and the selected employment data type. The instructions may also cause the processors to generate a plurality of statistical scores for the first employment data compared to the second employment data using a plurality of statistical models. The instructions may also cause the processors to calculate an impact score based on the plurality of statistical scores. The instructions may also cause the processors to generate an indicator based on the impact score. The instructions may also cause the processors to provide, via the graphical user interface, the indicator. Other embodiments of this aspect include corresponding computer systems, apparatus, and computer programs recorded on one or more computer storage devices, each configured to perform the actions of the methods.

Implementations may include one or more of the following features. The instructions that cause the processors to generate the indicator may also cause the processors to generate a graphical image of a geographical location related to the indicator. The instructions that cause the processors to display the indicator on the graphical image of the geographical location in the graphical user interface. Implementations of the described techniques may include hardware, a method or process, or computer software on a computer-accessible medium.

The foregoing, together with other features and embodiments will become more apparent upon referring to the following specification, claims, and accompanying drawings.

### BRIEF DESCRIPTION OF THE DRAWINGS

The disclosure will be readily understood by the following detailed description in conjunction with the accompanying drawings, wherein like reference numerals designate like elements, and in which:

FIG. 1 illustrates a simplified block diagram of a system for diversity analysis according to some embodiments.

FIG. 2 illustrates an exemplary method for diversity analysis according to some embodiments.

FIG. 3 illustrates an exemplary dashboard user interface view according to some embodiments.

FIG. 4 illustrates an exemplary user interface according to some embodiments.

FIG. 5 illustrates another exemplary dashboard user interface view according to some embodiments.

FIG. 6 illustrates another exemplary user interface according to some embodiments.

FIG. 7 illustrates another exemplary user interface according to some embodiments.

FIG. 8 depicts a simplified diagram of a distributed system for implementing an embodiment.

FIG. 9 is a simplified block diagram of a cloud-based system environment in which various storage-related services may be offered as cloud services, in accordance with certain embodiments.

FIG. 10 illustrates an exemplary computer system that may be used to implement certain embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to monitoring and analysis of large data sets. More particularly, data analysis techniques are described as applied to diversity monitoring in employment, hiring, and promotion practices. While the details and examples provided herein relate to diversity monitoring and analysis, the techniques described herein may be applied to monitoring and analysis of any large data sets for determination of the probability of events occurring. In certain embodiments, analysis techniques are described for analyzing employment, hiring, and promotion information to generate analysis results (e.g., diversity statistics) that indicate whether there are employment gaps related to diversity and a diverse workforce within an enterprise. Various inventive embodiments are described herein, including methods, systems, non-transitory computer-readable storage media storing programs, code, or instructions executable by one or more processors, and the like.

The data being analyzed may include multiple attributes. For example, employment information or employment data as described in this disclosure may include attributes such as employee name, employee location, facility at which the employee works, employee address, employee veteran status, employee disability status, employee age or date of birth, employee gender, employee salary, employee promotion history, employee employment date, employee review information, employee complaint information including complaints lodged by the employee and complaints lodged against the employee, employee race (also referred to herein as ethnicity), employee termination date, employee termination reason (e.g., voluntary vs. non-voluntary), employee job title, employee Equal Employment Opportunity (EEO) job category, and any other information about the employee that may be relevant to employment status. Employment information or employment data may also include candidate information for hiring such as the candidate name, candidate application date, whether the candidate was hired, candidate race, candidate age, candidate disability status, candidate veteran status, and any other information about the candidate that may be relevant to hiring status.

For the purposes of this application, employment data type may be used to identify diversity aggregates of a specific type related to specific employment acts. Employment data types may include hiring data, involuntary termination (i.e., firing) data, promotion data, current employment data, voluntary termination (i.e., quitting) data, salary data, and so forth.

Various classifications may be used for the data analysis. For example, in certain embodiments, diversity classifications may be used to classify an individual into one or more classes including, for example, a protected (unfavored) class versus a favored class. Other examples of diversity classifications include, for example, age, gender, disability status, veteran status, race, and so forth.

One of the attributes of the data being analyzed may include an Equal Employment Opportunity (EEO) job category, which may be any job category provided by the United States Department of Labor Equal Employment Opportunity Commission (EEOC). The EEOC also publishes EEO job codes that correspond to the EEO job categories.

As part of the data analysis, various data aggregates may be generated or computed based upon the available data. For example, a diversity aggregate may be computed where the diversity may be any aggregated information (or collection of information even if not aggregated) regarding a particular group of individuals for diversity analysis. For example, the diversity aggregate may be based on region, EEO job category, an employment data type, and/or a diversity classification. For example, a first diversity aggregate may be the number of female craft workers hired in the past year in the San Antonio Tex. facility of an enterprise. As another example, a second diversity aggregate may be all Native American employees having over an expected salary within the enterprise. Further, some aggregates may be nested, such that drilling down may be facilitated. For example, a third diversity aggregate may be nested within the second diversity aggregate such that the third diversity aggregate is all Native American employees having over an expected salary in the Florida facility of the enterprise.

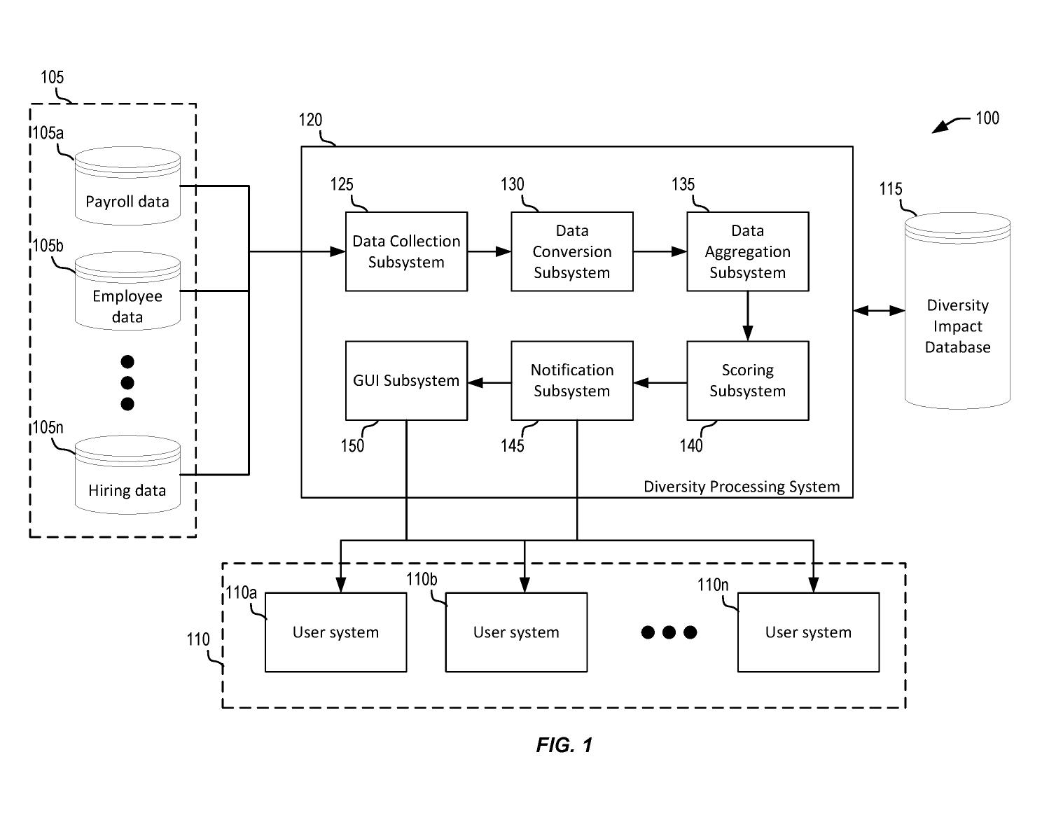

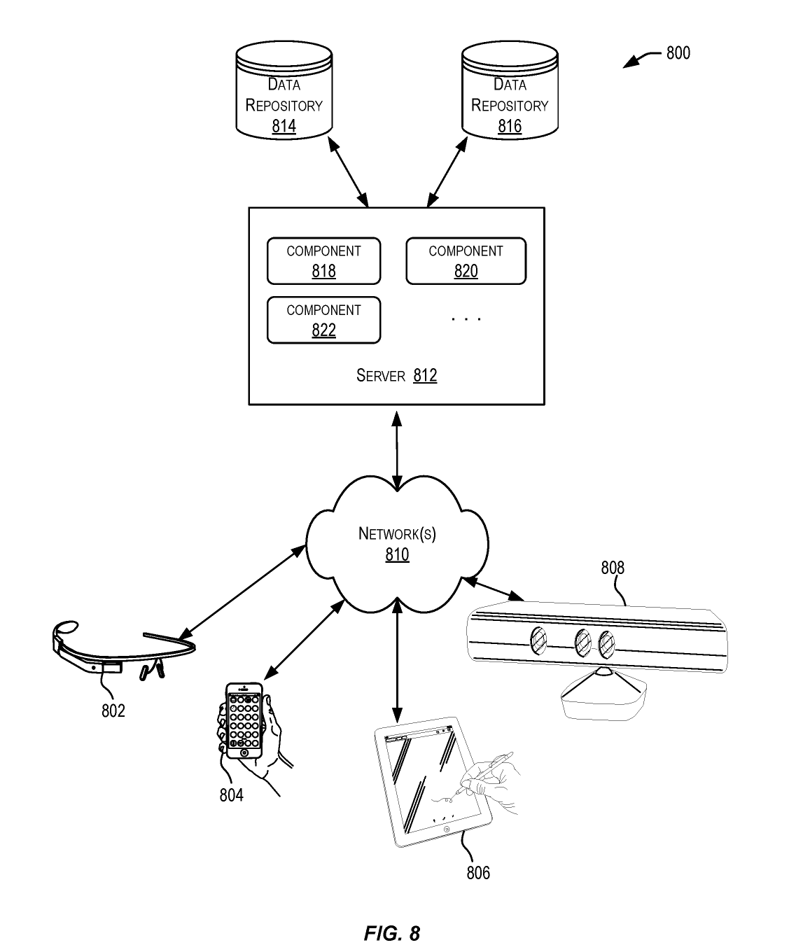

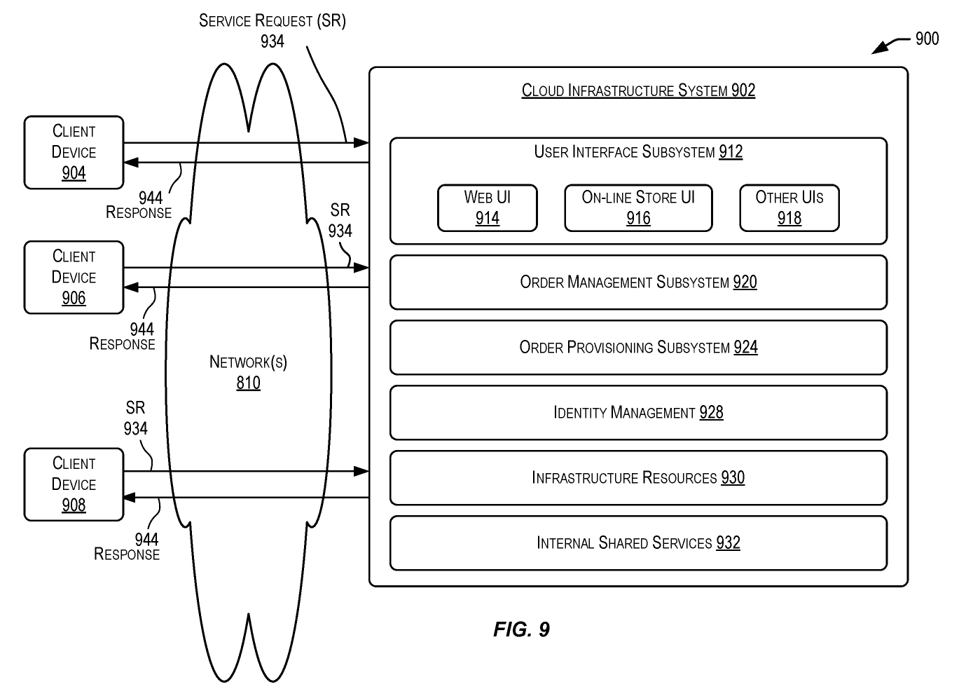

FIG. 1 is a simplified block diagram of a distributed environment 100 incorporating an exemplary embodiment. Distributed environment 100 may comprise multiple systems communicatively coupled to each other via one or more communication networks, such as network 810 or network 910 of FIGS. 8 and 9. The systems in FIG. 1 include one or more data processing systems 120, one or more user systems 110, one or more data sources 105, and a database 115 (or data store, in general) communicatively coupled to each other via one or more communication networks. Distributed environment 100 depicted in FIG. 1 is merely an example and is not intended to unduly limit the scope of claimed embodiments. One of ordinary skill in the art would recognize many possible variations, alternatives, and modifications. For example, in some implementations, distributed environment 100 may have more or fewer systems or components than those shown in FIG. 1, may combine two or more systems, or may have a different configuration or arrangement of systems.

Data sources 105, such as payroll data 105a, Employee data 105b, and hiring data 105n may include any number of data sources 105 that store employment related data for an enterprise. Each of the data sources 105 may store data relevant for analyzing employment and diversity practices within the enterprise. For example, one or more data sources 105 may include data about employees such as employee name, date of birth, veteran status, disability status, gender, and so forth. As another example, one or more data sources 105 may include data about potential employee candidates including name, date of birth, veteran status, disability status, gender, and so forth. One or more data sources 105 may also include data regarding promotions, hiring, and termination of employees. Data sources 105 may store data in one or different formats or forms including differing types of databases, different data structures, as well as differing formats for similar fields (e.g., date of birth may be stored as a numerical value in one database while date of birth may be stored as a string in another database).

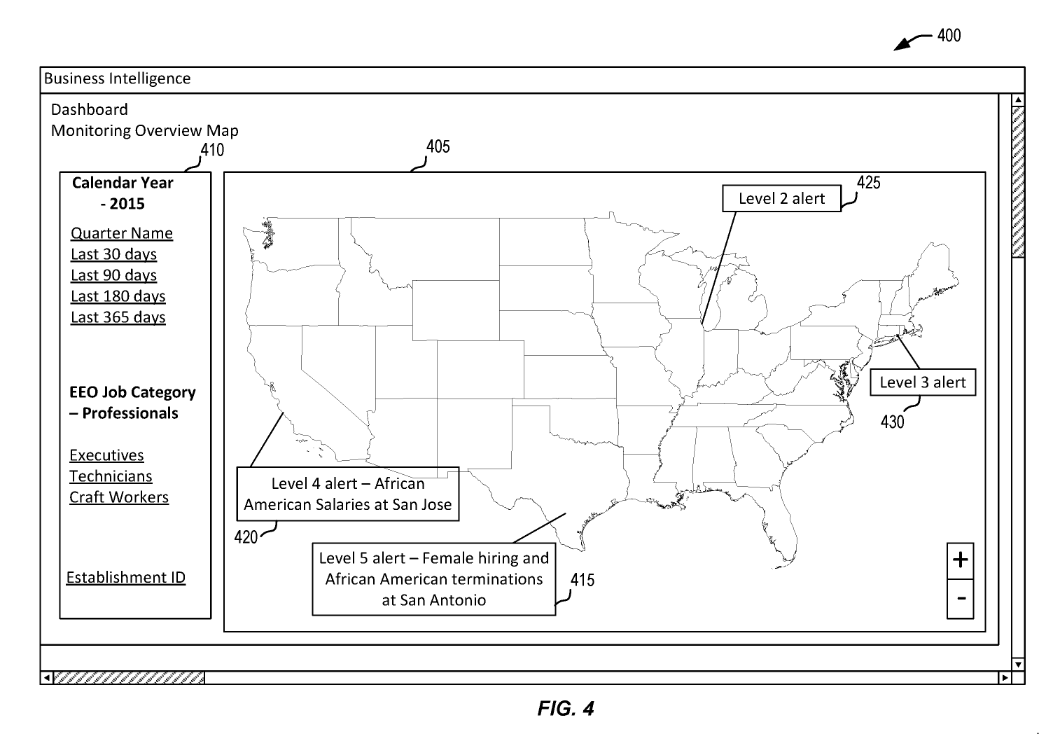

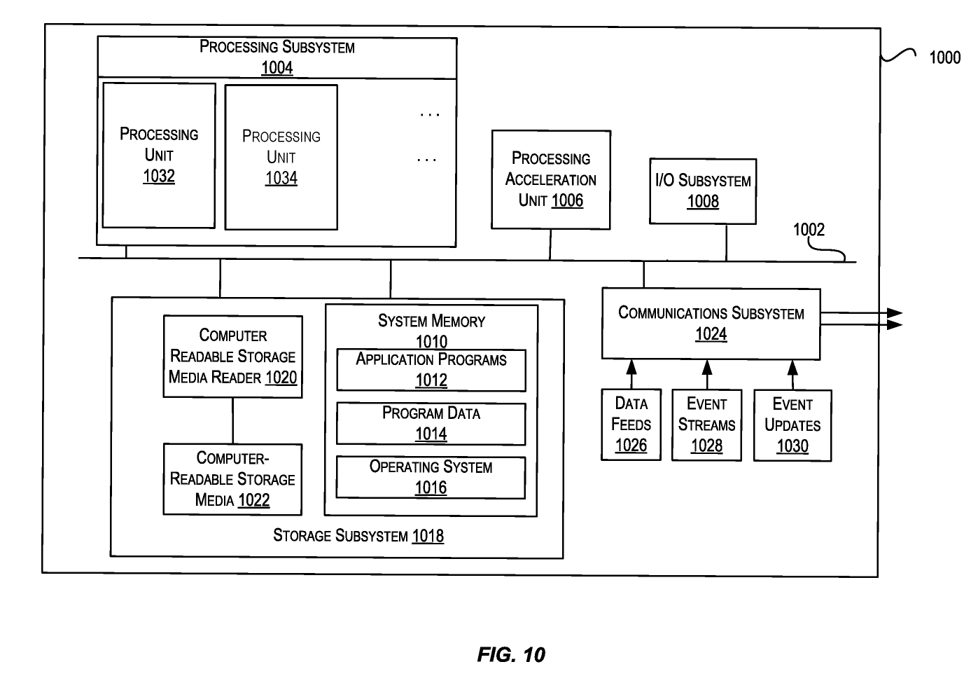

User systems 110 may be any suitable computer systems that may be used by a user to interact with diversity processing system 120. For example, analysis results generated by diversity processing system 120 may be transmitted to a user system 110 and may be output to a user via a graphical user interface (GUI) displayed by the user system 110. A user may also use a user system 110 to provide inputs to diversity processing system 120, where the inputs may be used by diversity processing system 120 as parameters for the analysis performed by diversity processing system 120. For example, the user may select specific parameters as described in FIGS. 4-7 to modify the displayed information in the GUI. User systems 110 may be computer system 1000 of FIG. 10. Although three user systems 110 are shown in FIG. 1, this is not intended to be limiting in any manner. In alternative embodiments, any number of user systems 110 may be supported by distributed system 100.

Diversity impact database 115 may be any suitable database (or data store) for storing data used by diversity processing system 120 for performing analysis. In certain embodiments, as described in more detail below, employee and employment data may be stored in diversity impact database 115 once it is obtained from data sources 105 and converted into a single, or common, format. In certain embodiments, diversity impact database 115 may also store the aggregated data.

Diversity processing system 120 may be implemented using one or more suitable computer systems, such as, for example, one or more of computer system 1000 of FIG. 10. In the embodiment depicted in FIG. 1, diversity processing system 120 includes a data collection subsystem 125, data conversion subsystem 130, data aggregation subsystem 135, scoring subsystem 140, notification subsystem 145, and graphical user interface subsystem 150. While specific subsystems are depicted within diversity processing system 120, more or fewer subsystems may be used to incorporate the described functionality without impacting the scope of this disclosure.

Data collection module 125 may be implemented using software executed by one or more processors, hardware, firmware, or combinations thereof, and is configured to collect data from data sources 105. The data used to identify diversity indicators may be stored in disparate data sources 105 having various formats. A diversity indicator, for example, may refer to an indicator generated by diversity processing system 120 as described in more detail herein. Various techniques may be used to collect data from data sources 105. In certain embodiments, the data sources 105 may be configured to transmit data periodically to data collection subsystem 125. In other embodiments, data collection subsystem 125 may pull the relevant data from data sources 105, for example, by requesting the relevant data, which is then transmitted to data collection subsystem 125 by one or more of data sources 105.

Data conversion subsystem 130 may be implemented using software executed by one or more processors, hardware, firmware, or combinations thereof, and is configured to convert data collected by data collection subsystem 125 into a single, or common, format to facilitate analysis. For example, while some data sources 105 may store date of birth as a string, others may store date of birth as a numerical value. Data conversion subsystem 130 may convert all like values to the same format for use by diversity processing system 120. Optionally, data conversion subsystem 130 may store the converted data in diversity impact database 115.

Data aggregation subsystem 135 may be implemented using software executed by one or more processors, hardware, firmware, or combinations thereof, and is configured to aggregate the data converted by data conversion subsystem 130. After data conversion subsystem 130 has converted the data to be a standard or common format, data aggregation subsystem 135 can aggregate the data based on region, diversity classification, and employment data type. For example, an enterprise may have locations in various regions of the country and world. The data can be aggregated by region such that nested levels can be identified such as a first local level (e.g., Boston), a higher state level (e.g., Massachusetts), an even higher country level (e.g., United States), and an even higher continent level (e.g., North America) may exist. Further, the data can be aggregated by diversity classification. Diversity classifications may include gender, race, veteran status, disability status, and so forth. The data can further be aggregated by employment data type. Employment data type may include hiring, involuntary termination (i.e., firing), promotion, currently employed, voluntary termination (i.e., quitting), salary, and so forth. As an example, a diversity aggregate may be the number of female candidates hired in Boston over the last 3 months. As another example, a diversity aggregate may be the number of veterans promoted in St. Louis over the last year. Optionally, enterprises may configure the time windows over which diversity aggregates are calculated. Further, optionally enterprises may configure regions over which diversity aggregates are calculated. In some embodiments, diversity classifications and employment data type may also be configured. Optionally, data aggregation subsystem 135 may store the aggregates in diversity impact database 115.

Scoring subsystem 140 may be implemented using software executed by one or more processors, hardware, firmware, or combinations thereof, and is configured to score aggregates based on a comparison aggregate. Scoring subsystem 140 may score the aggregates using one or more statistical models or statistical metrics. For example, statistical models or metrics used for scoring the aggregates may include the ⅘^{th} (i.e., 80%) rule, the two-tailed Z-test, Pearson's Chi-squared test, Fisher's Exact Test, and the like. In some embodiments, variations on the statistical models or metrics may be used. For example, Fisher's Exact Test is a computationally expensive statistical model, so a computationally efficient version of Fisher's Exact Test may be used. Further, Pearson's Chi-squared test may use Upton's correction, for example. The specific selection of statistical models or metrics used to score the aggregates may be configurable in some embodiments.

Scoring subsystem 140 may score each diversity aggregate as compared to each other comparable diversity aggregate and optionally store the scores in diversity impact database 115. Scoring subsystem 140 may first generate statistical diversity scores for each diversity aggregate for each statistical model. For example, scoring subsystem 140 may obtain a first diversity aggregate for scoring and a second diversity aggregate for comparison. As an example, the first diversity aggregate (for scoring) may be the number of disabled employees promoted in the Los Angeles, Calif. region over the last year, and the second diversity aggregate (for comparison) may be the number of non-disabled employees promoted in the Los Angeles, Calif. region over the last year. Scoring subsystem 140 may run each statistical model on the diversity aggregates and generate a statistical diversity score for each statistical model. For example, a first statistical diversity score may be based on the ⅘^{th} rule, a second statistical diversity score may be based on the Pearson's Chi-squared test, a third statistical diversity score may be based on the two-tailed Z-test, and a fourth statistical diversity score may be based on Fisher's Exact test. In this example, the first diversity aggregate (e.g., the number of disabled employees promoted in the Los Angeles Calif. region over the last year) will have four statistical diversity scores.

Scoring subsystem 140 may assign a normalized score to each statistical diversity score generated. In some embodiments, some statistical models or metrics may generate statistical diversity scores on differing scales. To facilitate combination and analysis of the statistical diversity scores, the various statistical diversity scores may be normalized to a common scale. For example, if the Fisher's Exact test resulted in a statistical diversity score indicating that the number of disabled employees promoted in the Los Angeles, Calif. region over the last year is nearly impossibly low (e.g., significantly less than 1%) without discrimination against disabled employees, the normalized score may be 10 on a scale of 1-10. Similarly, if the two-tailed Z-test results in a statistical diversity score indicating that the number of disabled employees promoted in the Los Angeles, Calif. region over the last year has a probability of less than 1% without discrimination against disabled employees, the normalized score may be 5 on the scale of 1-10. Each statistical diversity score may similarly be normalized to a single scale. For example purposes, a normalized scale of 1-10 is used herein, where a score of 10 indicates a diversity issue (i.e., the probability of discrimination is practically certain) and a score of 1 indicates no issue (i.e., the chances of discrimination is practically zero). Any normalized scale (e.g., 1-100; 1-1000; 0-5; −10-10; or any other scale) can be used, as long as each statistical diversity score is normalized to the same scale. Normalizing the statistical diversity score for each statistical model or metric allows for combination of the statistical diversity scores as shown below to result in a meaningful diversity impact score and/or allows for meaningful analysis and comparison of the statistical diversity scores based on various statistical models or metrics.

Once the normalized statistical diversity scores for each statistical model are generated for the diversity aggregate being analyzed, scoring subsystem 140 may apply a weight to each normalized statistical diversity score. For example, Fisher's Exact Test is generally a good indicator across all data set sizes, but the ⅘^{th} rule is a less accurate indicator, so the normalized statistical diversity score based on Fisher's Exact Test may have a higher weight than the normalized statistical diversity score based on the ⅘^{th} rule. Further, Pearson's Chi-squared test is a good indicator when the data set has at least 30 data points, and the two-tailed Z-test is a good indicator when the data set has more than 100 data points. Scoring subsystem 140 may identify the data set underlying the diversity aggregate being analyzed to determine the number of data points in the data set and set a weight for each of the normalized statistical diversity scores based at least in part on the size of the data set.

Scoring subsystem 140 may adjust the weight assigned to each normalized statistical diversity score for each diversity aggregate that is compared and analyzed (i.e., the weight applied may be different for each diversity aggregate). Further, once an initial weight is applied to each normalized statistical diversity score, scoring subsystem 140 may use various techniques, including machine learning techniques, to modify the weights until the root mean square error (or other error measure) between the individual normalized statistical diversity scores and the single diversity impact score is minimized. Once a final weight is applied to each normalized statistical diversity score, the weighted normalized statistical diversity scores may be combined to generate a single diversity impact score for the diversity aggregate.

Returning to the example of the number of disabled employees promoted in the Los Angeles, Calif. region over the last year, the example following weights and normalized statistical diversity scores may be generated in one example instance:

Fisher's Exact Test score 10 with a weight of 0.4,

⅘^{th} rule score 6 with a weight of 0.1,

Pearson's Chi-square score 9 with a weight of 0.3, and

Two-tailed Z-test score 7 with a weight of 0.2.

Given the above scores and weights, multiplying each normalized statistical diversity score by its assigned weight and adding each together may provide a diversity impact score of, for example, 8.7. For example:

Diversity impact score=0.4(10)+0.1(6)+0.3(9)+0.2(7)=8.7.

A diversity impact score of 8.7 may suggest that a serious issue may exist with respect to disabled employee diversity in Los Angeles over the past year. This diversity impact score may be considered a diversity indicator. Optionally, scoring subsystem 140 may store the normalized statistical diversity scores and/or the diversity impact score for each diversity aggregate in the diversity impact database 115.

Notification subsystem 145 may be implemented using software executed by one or more processors, hardware, firmware, or combinations thereof, and is configured to generate notifications based on the scores generated by scoring subsystem 140. For example, scores over 4 may be sufficient to generate a notification, which may be sent via short message service (SMS) messaging to users that are configured to receive such notifications. In some embodiments, the notifications may appear to the user on their graphical user interface when the user logs into the graphical user interface. For example, notifications may provide the diversity indicators calculated by the diversity processing system 120. Example notifications are shown in dashboards 300, 400, 500, 600, and 700 herein.

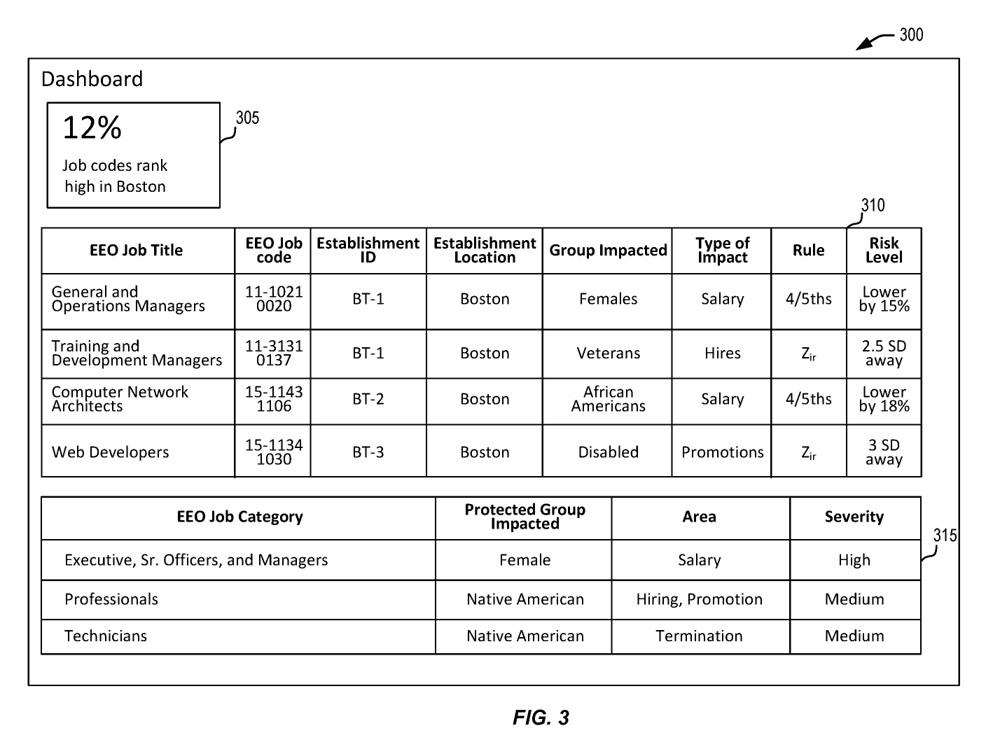

Graphical User Interface (GUI) subsystem 150 may be implemented using software executed by one or more processors, hardware, firmware, or combinations thereof, and is configured to generate a GUI for users of user system 110 to view the employment information collected from data sources 105 and diversity data as aggregated, scored, and analyzed by the subsystems of diversity processing system 120 described above. Examples of such GUIs are shown in more detail in FIGS. 3-7.

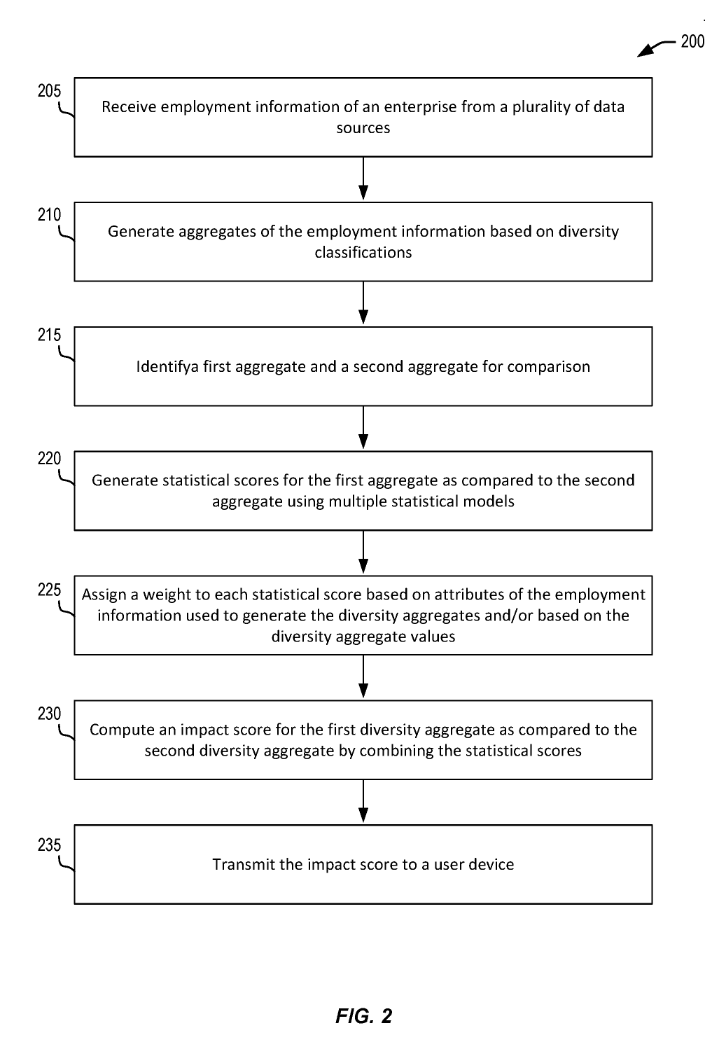

FIG. 2 illustrates an exemplary method 200 that may be performed by, for example, diversity processing system 120 of FIG. 1. The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). In some embodiments, the processing may be performed by diversity processing system 120 depicted in FIG. 1.

Method 200 may begin at step 205 with receiving employment information of an enterprise from a plurality of data sources. For example, data collection subsystem 125 may collect data from data sources 105. The employment information may be received from data sources that store data in various formats. For example, some of the data sources may store data in structured query language (SQL) databases while others may be non-SQL databases. Further, the data types may be of various formats. In some embodiments, the data collected may be converted to a single format by, for example, data conversion subsystem 130 of FIG. 1. Optionally, the collected data and/or the converted data may be stored in a database, such as, for example, diversity impact database 115.

Method 200 may proceed at step 210 with generating one or more diversity aggregates of the employment information based on diversity classifications. For example, data aggregation subsystem 135 may aggregate the employment information. The diversity aggregates may be based on diversity classifications such as, for example, age, gender, disability status, veteran status, race, and so forth. The diversity aggregates may be further computed based on region, employment data type (e.g., hiring, termination, promotion) and for a specified period of time. For example, for age-based diversity classification, a diversity aggregate may be generated such as all employees 40 years-old or older (diversity classification) that were promoted (employment data type) within the last year (specified period of time) in all Arizona facilities (region) of the enterprise. A second diversity aggregate may also be generated such as all employees under 40 years-old that were promoted within the last year in all Arizona facilities of the enterprise.

Method 200 may proceed at step 215 with identifying at least two diversity aggregates for comparison. For example, scoring subsystem 140 may identify two diversity aggregates to compare. As an example, using diversity aggregates determined based upon veteran status classification, the first diversity aggregated identified for comparison may be the number of veterans hired in the Milwaukee, Wis. location of the enterprise over the past six months. The second diversity aggregate (also referred to as a comparison diversity aggregate) to be compared with the first diversity aggregate may be the number of non-veterans hired in the Milwaukee, Wis. location of the enterprise over the past six months. Additionally, a third diversity aggregate selected for comparison may be the number of veterans that were candidates in the Milwaukee, Wis. location of the enterprise over the past six months.

In some embodiments, the diversity processing system 120 may identify the first diversity aggregate based on selections from a user, such as selections from users through a GUI (e.g., dashboards 300, 400, 500, 600, or 700). In some embodiments, the user may select the diversity classification, time frame, region, and/or employment data type for review. For example, a user may select women hired during 2017 in all Detroit, Mich. facilities of the enterprise. In some embodiments, a catalog (e.g., pre-configured or user configured) of diversity aggregates may be automatically generated, for example, periodically. In addition to the first diversity aggregate, the second diversity aggregate is identified. The second diversity aggregate may be a comparable diversity aggregate that is related to the first diversity aggregate. For example, the second diversity aggregate may have the same employment data type, region, and time frame. For example, if the first diversity aggregate is women hired during 2017 in all Detroit, Mich. facilities, the second diversity aggregate may be men hired during 2017 in all Detroit, Mich. facilities. The first diversity aggregate and the second diversity aggregate are related because they are comparable. The time frame (e.g., 2017), employment data type (e.g., hiring), and region (e.g., Detroit, Mich.) are the same, and the diversity classification of the first diversity aggregate (e.g., females) is one that would be compared with the diversity classification of the second diversity aggregate (e.g., males). In some embodiments, diversity processing system 120 may select the second diversity aggregate based on the first diversity aggregate diversity classification. In some embodiments, the user may select the second diversity aggregate for comparison using a GUI.

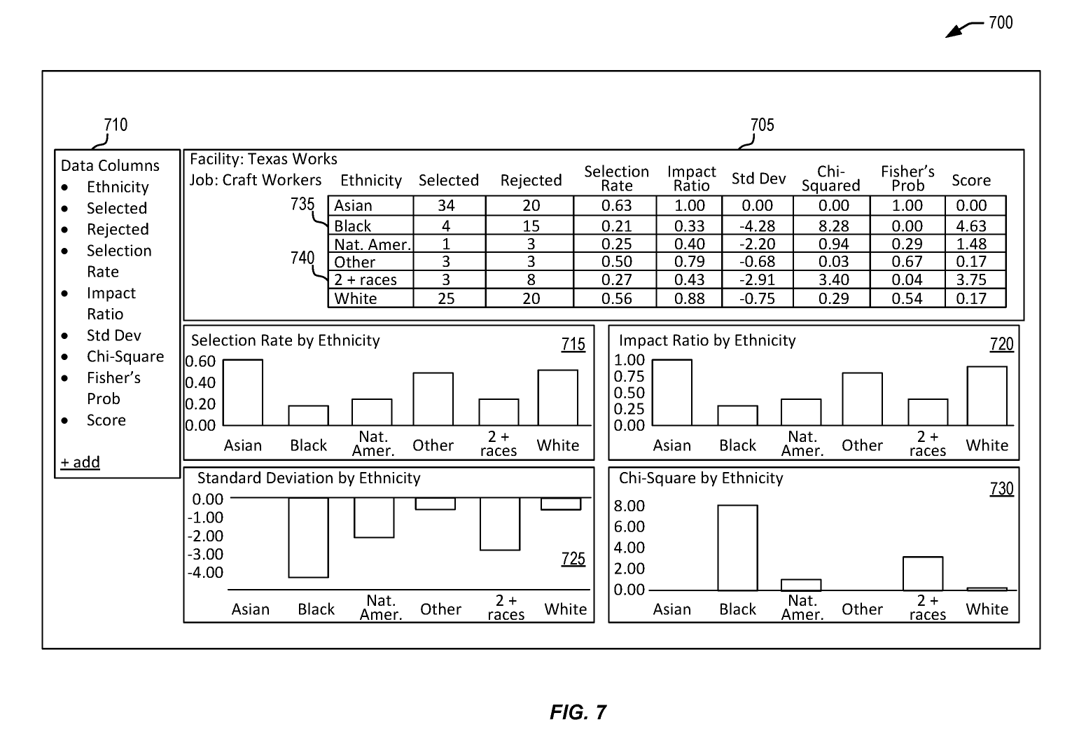

The statistical models and metrics often compare two aggregates. For age-based classifications, the comparison is typically 40 years-old or older as compared to under 40 years old. For gender-based classifications, the comparison is typically male as compared to female. For veteran status-based classifications, the comparison is typically veteran as compared to non-veteran. For disability status-based classifications, the comparison is typically disabled as compared to not disabled. Race-based classifications are typically broken into favored class as compared to each non-favored class. This can be seen with respect to dashboard 700 of FIG. 7. In some embodiments, combinations of diversity classifications can be included to more specifically target diversity indicators. For example, a first diversity aggregate may be African-American women aged 40 and over who were promoted in the past 6 months in all California facilities, and a second diversity aggregate for comparison may be white men under 40 who were promoted in the past 6 months in all California facilities.

Method 200 may proceed at step 220 with generating statistical diversity scores for the diversity aggregates selected in step 215 for comparison using multiple statistical models. For example, scoring subsystem 140 of FIG. 1 may generate statistical diversity scores for each statistical model for the diversity aggregate selected to analyze in comparison with the diversity aggregates used for comparison. Further, the statistical diversity scores may be normalized to a single scale. As previously described, the statistical models may include Fisher's Exact Test, Pearson's Chi-squared test, the two-tailed Z-Test, and the ⅘^{th} rule.

As an example, scoring subsystem 140 may generate a first statistical diversity score based on Fisher's Exact Test for a first diversity aggregate of women promoted in the past 6 months in the New York office of the enterprise as compared to the second diversity aggregate of men promoted in the past 6 months in the New York office of the enterprise. Scoring subsystem 140 may then generate a first normalized statistical diversity score based on the first statistical diversity score. Scoring subsystem 140 may also generate a second statistical diversity score based on Pearson's Chi-squared test for the first diversity aggregate compared to the second diversity aggregate. Scoring subsystem 140 may then generate a second normalized statistical diversity score based on the second statistical diversity score. Scoring subsystem 140 may also generate a statistical diversity score for the first diversity aggregate compared to the second diversity aggregate for any other statistical models and/or metrics as configured by the diversity processing system 120. Scoring subsystem 140 may similarly generate a normalized statistical diversity score for each of the statistical diversity scores.

Method 200 may proceed at step 225 with applying a weight to each statistical diversity score generated in step 220. Stated differently, as described in step 220, a statistical diversity score is calculated for each set of compared diversity aggregates (the first diversity aggregate and the comparison diversity aggregate). In step 225, a weight is determined for each statistical diversity score calculated in step 220. The weight applied to each statistical diversity score may be based on attributes of the underlying diversity aggregates and/or based on the diversity aggregate value. For example, Pearson's Chi-squared test provides a more reliable indicator when the underlying data set used to generate the aggregate includes more than thirty data points. The size of the underlying data set for the diversity aggregate may be used to set a weight for at least some of the statistical diversity scores. Additionally, the initial weight may be used in a machine learning calculation that adjusts the weights for each statistical diversity score to minimize the root mean square error or a similar error metric, between each of the statistical diversity scores and the final diversity impact score.

Returning to the example from step 220, scoring subsystem 140 may generate a first statistical diversity score based on Fisher's Exact Test for the first diversity aggregate of women promoted in the past 6 months in the New York office of the enterprise as compared to the second diversity aggregate of men promoted in the past 6 months in the New York office of the enterprise. Scoring subsystem 140 may also generate a first normalized statistical diversity score. Scoring subsystem 140 may also generate a second statistical diversity score based on Pearson's Chi-square test for the first diversity aggregate as compared to the second diversity aggregate, a third statistical diversity score based on the ⅘^{th} rule for the first diversity aggregate as compared to the second diversity aggregate, and a fourth statistical diversity score based on the two-tailed Z-test for the first diversity aggregate as compared to the second diversity aggregate. Scoring subsystem 140 may also generate a second normalized statistical diversity score based on the second statistical diversity score, a third normalized statistical diversity score based on the third statistical diversity score, and a fourth normalized statistical diversity score based on the fourth statistical diversity score. The result of this process may be four statistical diversity scores for the first diversity aggregate as compared to the second diversity aggregate, with each of the four statistical diversity scores normalized to the same scale based on their relative probabilities.

At step 225, continuing with the example, scoring subsystem 140 may analyze the data underlying the first diversity aggregate and determine that the first diversity aggregate has underlying data made up of information regarding 40 women. At 30 data points, Pearson's Chi-square test is known to be reliable. Fisher's Exact Test is known to be reliable with any size data set. The ⅘^{th} rule is known to be less reliable than Fisher's Exact Test, Pearson's Chi-square test, and the two-tailed Z-test. The two-tailed Z-test is known to be more reliable with more than 100 data points. Accordingly, initial weights of, for example, 0.4 for the normalized statistical diversity score based on Fisher's Exact Test, 0.3 for the normalized statistical diversity score based on Pearson's Chi-square test, 0.2 for the normalized statistical diversity score based on the two-tailed Z-test, and 0.1 for the normalized statistical diversity score based on the ⅘^{th} rule may be initially assigned. These initial weights may be used in a machine learning algorithm as initial values to minimize the root mean square error or a similar error metric, between each of the statistical diversity scores and the final diversity impact score. The final diversity impact score may be calculated for use in the machine learning algorithm for each set of weights until the root mean square error (or another error metric) is minimized.

Method 200 may proceed at step 230 with computing a diversity impact score for the first diversity aggregate as compared to the second diversity aggregate. The diversity impact score may provide a single score which may indicate whether the individuals incorporated in the first diversity aggregate (the disfavored class) may be experiencing discrimination (for example, as compared to the favored class, although discrimination may be identified by comparing, for example, the number of individuals of a disfavored class hired as compared to the number of disfavored candidates without a comparison to the favored class). By generating a single diversity impact score for each diversity aggregate as compared to a comparison diversity aggregate, the amount and level of discrimination throughout the enterprise may be monitored. High diversity impact scores (what constitutes a high diversity impact score may be configured based on the normalized scale used) may be considered a diversity indicator and notifications may be generated as described herein.

The diversity impact score may be calculated by combining the statistical diversity scores using the weights. For example, the each normalized statistical diversity score may be multiplied by its assigned weight and the values added together to get a final diversity impact score as described in the diversity impact score calculation described with respect to FIG. 1. The diversity impact score may be a value on the normalized scale that indicates whether there is a risk of discrimination based on the diversity classification, for the period of time reviewed, in the region reviewed (e.g., age discrimination in 2017 in the St. Louis, Mo. location of the enterprise). On a normalized scale of 1-10, with the probability of discrimination increasing as the score increases, a score of 1-3 may indicate low risk of discrimination, a score of 4-7 may indicate a medium risk of discrimination, and a score over 7 may indicate serious risk of discrimination.

Method 200 may proceed at step 235 with transmitting the diversity impact score to a user device. For example, notification subsystem 145 may transmit a notification for display on a user device 110, such as an SMS message sent to a user's mobile phone. Alternatively, a notification may be generated for display on user device 110 when the user logs into the GUI provided by GUI subsystem 150. In some embodiments, the notification and/or information provided in a GUI may provide analysis of the diversity impact score. For example, if the diversity impact score is over a threshold value (e.g., 8.0 or higher on the above described normalized scale of 1-10), the score may be flagged as a diversity indicator that should be addressed immediately. High scores that indicate a likelihood of discrimination suggest a risk for the enterprise. For example, the enterprise may face sanctions and legal action from the Equal Employment Opportunity Commission and/or civil legal action by individuals. Further, the benefits of a fairly employed diverse workforce are numerous, as previously described. There may also be mid-range scores (e.g., scores between 4.0 and 6.0 and/or scores between 6.0 and 8.0) that may be flagged differently than the higher scores as a diversity indicator. The mid-range scores may also indicate a risk, although a lower risk than higher scores, that should be addressed. For example, scores between 6.0 and 8.0 should be addressed quickly, while scores between 4.0 and 6.0 suggest a lower risk and may not be addressed as quickly. Low scores (e.g., scores under 4.0) may indicate a low enough score to not generate a notification. In some embodiments, highlighting may be used to indicate the severity of the risk associated with any given notification or diversity impact score. For example, a score of 0.0 may indicate no risk and be color-coded green while a score of 10.0 may indicate extreme risk and be color-coded red. The spectrum of colors between green and red may be used as the severity of the risk increases.

As described with respect to dashboards 300, 400, 500, 600, and 700, users may see the diversity impact scores and use the analysis to make modifications to hiring, firing, promotion, salary, and other employment practices based on the region and impacted individuals. In addition, diversity training may be developed to target issues that are identified by the diversity impact scores.

As indicated above, the particular sequence or order of steps depicted in FIG. 2 is not intended to be limiting. In certain alternative embodiments, the steps may be performed in some different order or some steps may also be performed in parallel. For example, while steps 205 and 210 are shown as occurring in a particular order in flowchart 200 in FIG. 2, this is not intended to be limiting. In alternative embodiments, employment information may be collected continuously, and the diversity aggregates may be generated while employment information is added to the diversity impact database. In yet other embodiments, the processing in steps 220, 225, and 230 may overlap or may be performed in parallel, particularly on multiple diversity aggregates.

FIG. 3 illustrates an example graphical user interface of a dashboard 300. A user, for example, a human resources officer of the enterprise, may use the dashboard 300 to get an overview of diversity employment information and flagged issues using the dashboard. The values generated and shown in dashboard 300 may be calculated by diversity processing system 120 and provided by GUI subsystem 150. Indicator 305 may be used to highlight issues and/or provide notifications that may be generated by notification subsystem 145. In the present example, indicator 305 is identifying that the Boston region or Boston facility has 12% of the EEO job codes indicating an issue.

Table 310 indicates further information related to the indicator 305. For example, the first row entry of table 310 indicates that General and Operations Managers (which is an Equal Employment Opportunity (“EEO”) job title used by the United States Equal Employment Opportunity Commission), has an EEO job code of 11-1021 0020 and in the facility designated by the enterprise as BT-1, located in Boston, Females may have a lower salary (than men) by 15% if reviewed using the ⅘^{th} rule for that job title. The EEO job title, EEO job code, and/or EEO job category may be a further way to aggregate the employment data aggregated by data aggregation subsystem 135. As discussed above, a statistical diversity score may be generated for the diversity aggregation using the ⅘^{th} rule (indicated in the column titled “Rule”). The diversity aggregation used in this example may be females with a salary over an expected value within the EEO job code in the Boston region of the enterprise using a current data snapshot. The comparison diversity aggregation may be males with a salary over the expected value within the EEO job code in the Boston region of the enterprise using the current data snapshot.

The second row entry of table 310 indicates that Training and Development manager candidates in the Boston region at facility BT-1 may not be hired if the candidate is a Veteran based on the two-tailed Z-Test because a review of that diversity aggregate indicates 2.5 standard deviations away from expected hiring for that group of candidates. The two-tailed Z-Test value provides a value of the number of standard deviations away the first diversity aggregate is from the comparison diversity aggregate. In this example, veterans hired in Boston is the first diversity aggregate and non-veterans hired in Boston may be the comparison diversity aggregate. The two-tailed Z-test may provide the score of 2.5 standard deviations, meaning that veterans hired in Boston is 2.5 standard deviations away from non-veterans hired in Boston. Accordingly, 2.5 may be the statistical diversity score based on the two-tailed Z-test generated by scoring subsystem 140 as described above.

The third row entry of table 310 indicates that Computer Network Architects employed in Boston at facility BT-2 that are African American may have a lower salary by 18% than the favored class (not shown) beyond the 80% rule if reviewed using the ⅘^{th} rule for that job title. The fourth row entry of table 310 indicates that Web Developers employed in Boston at facility BT-3 that are disabled may not be promoted because the two-tailed Z-test indicates 3 standard deviations away from the favored class of non-disabled employees.

Table 315 may provide a view of data across the entire enterprise based on EEO job category. For example, the first row entry in table 315 indicates that there is a severe (high severity) issue with salaries of females in Executive, Sr. Officers, and Manager roles within the enterprise. While no specific diversity impact scores are provided in this example, the diversity impact score may be generated and used to assign the severity to each of the rows in table 315. As an example, the diversity impact score for female employees in the Executive, Sr. Officer, and manager roles within the company may have low salaries that resulted in a diversity impact score of over 4.0 on the 1-10 normalized scale described above. As further shown as examples, the second row entry in table 315 indicates that there is a medium severity (e.g., diversity impact score of between 4.0 and 6.0 on a normalized scale of 1-10) issue with hiring and promotions of Native Americans in Professional roles within the enterprise. Further, the third row entry in table 315 indicates that there is a medium severity issue with termination of Native Americans in Technician roles within the enterprise.

Dashboard 300 is an example of one way to display information generated by system 100 and particularly by diversity processing system 120. Many other implementations may be used.

FIG. 4 illustrates another exemplary graphical user interface of a dashboard 400 providing a visual geographical indication of diversity impact data. A user, for example, a human resources officer of the enterprise, may use the dashboard 400 to get an overview of diversity employment information and flagged issues using the dashboard 400. The identified issues and underlying data may be calculated by diversity processing system 120 and provided by GUI subsystem 150.

Dashboard 400 may include, for example, map 405 and selection menu 410. Selection menu 410 may include various links for selecting a specific timeframe to view. Selection of a different view may cause new aggregates to be generated by, for example, data aggregation subsystem 135. Optionally, the diversity aggregates needed for each view selected in selection menu 410 may already be calculated and stored in diversity impact database 115. Optional selections within selection menu 410 may include diversity classifications (e.g., gender, race, veteran status, disability status, age, and so forth), time period (e.g., calendar year, quarter, last 30 days, last 90 days, and so forth), EEO job category (or EEO job title or EEO job code), regional area (e.g., by establishment ID, by facility name, by geographic area such as city, state, or country, and so forth). The selection menu 410 may be configured to select any combination of data for aggregation. Selection menu 410 in the example of dashboard 400 indicates that calendar year 215 is selected. A different time selection of Quarter Name, last 30 days, last 90 days, last 180, days and last 365 days may be offered or any other time selections may be available. Further, selection menu 410 indicates that EEO job category of Professionals is selected. Other selections of Executives, Technicians, or Craft workers are provided, or any other job categories may be provided. Selection menu 410 indicates that no specific Establishment ID is selected, but clicking the Establishment ID link in selection menu 410 may provide, for example, a list of Establishment IDs for the user to select from. Any suitable selections may be available in selection menu 410 to modify the information provided in map 405.

Map 405 may include a map of a geographic region, in this example the United States. The map 405 may highlight areas that have potential risk based on the values in selection menu 410. In this example, the map may indicate issues or highlight areas that have potential risk with respect to Professionals in calendar year 2015 throughout the United States. For example, notification 415 provides a level 5 alert regarding female hiring for Professional roles and African American terminations for Professional roles in San Antonio, Tex. in 2015. In some embodiments, selection of the notification 415 may allow the user to drill down into data regarding the diversity aggregation and data that the level 5 alert is related to. Notification 415 may be generated by, for example, notification subsystem 145 of FIG. 1, and GUI subsystem 150 may incorporate the notification 415 into the map 405. Note that notification 415 includes a leader line that points to San Antonio, Tex., to indicate the geographic region.

Map 415 may also include other notifications 420, 425, and 430. The notifications 420, 425, and 430 may also have leader lines pointing to the area to which the notification relates. In some embodiments, the notifications may be color coded to indicate severity and draw the user's attention to the higher severity alerts. As previously mentioned, clicking the notification on the map 405 may allow the user to drill down to the data that was used to generate the notification.

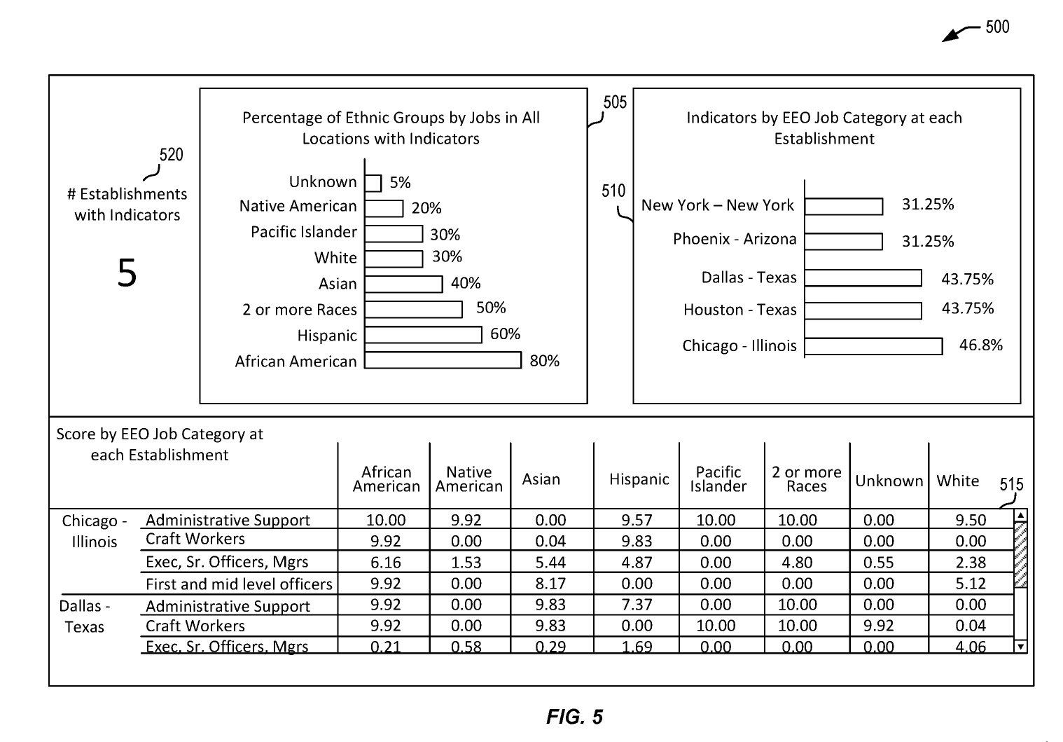

FIG. 5 illustrates another exemplary graphical user interface of a dashboard 500 providing a visual geographical indication of diversity impact data. A user, for example, a human resources officer of the enterprise, may use the dashboard 500 to get an overview of diversity employment information and flagged issues (diversity indicators) using the dashboard 500. The identified issues and underlying data may be calculated by diversity processing system 120 and provided by GUI subsystem 150.

Dashboard 500 may include a notification 520 generated by notification subsystem 145. Notification 520 may indicate that 5 establishments (e.g., enterprise facilities) have indicators that suggest diversity issues. Graph 505 may provide, for example, racial diversity information. For example, graph 505 may indicate a percentage of ethnic groups by job in all enterprise locations. As shown in graph 505, for example, 80% of the EEO job categories in all locations have indicators for African American employees or candidates. This may indicate at a high level that there is a gap in African American diversity within the enterprise. A percentage value may exist for each categorized race as shown in graph 505. Clicking on a portion of the graph may allow the user to drill down to the underlying data. For example, clicking the 80% bar or the word “African American” may allow the user to drill down to detailed data for African American specific data. For example, a map such as map 405 may be shown to provide the user with details on the specific geographic locations in which diversity indicators have been generated. As mentioned above, the aggregated data may be nested, such that clicking through may allow the user to drill down to specific aggregates and/or data sets of information that may be stored, for example, in diversity impact database 115.

Dashboard 500 may also include graph 510 that may provide, for example, indicators by EEO job category at each establishment. For example, an enterprise may have a facility in New York, Phoenix, Dallas, Houston, and Chicago. Graph 510 may indicate that 31.25% of the EEO job categories in the New York office have indicators associated for at least one diversity aggregate (e.g., gender, age, disability status, veteran status, race, and so forth) and may further indicate by employment data type (e.g., hiring, salary, promotions, and so forth). As can be appreciated, for each location and time frame, there are numerous diversity classifications and employment data types. For example, for each location and time frame, the data can be aggregated by gender (male and female) hiring, gender terminations, gender promotions, gender salary, and so forth. Data can further be aggregated by each race and each employment data type (i.e., African American hiring, African American terminations, African American salary, African American promotions, Caucasian hiring, Hispanic hiring, and so forth). As can be appreciated, numerous aggregations may be identified for each location and time frame. Clicking on a portion of the graph 510 may again allow the user to drill down to specific data for that establishment.

Dashboard 500 may also include table 515, which may provide the diversity impact score generated by scoring subsystem 140 as described with respect to FIG. 1 for each race, further based on EEO job category and based on location. For example, the diversity impact score for African American employees in Administrative Support positions in the Chicago location of the enterprise is 10.00. On a scale of 1-10, a 10.00 indicates severe risk of issues for the enterprise because there is an exceptionally high likelihood of discrimination that should be addressed immediately. As another example, the diversity impact score for Native American employees in Craft Worker positions i the Dallas, Tex. location of the enterprise is 0.00. A score of 0.00 on the normalized scale of 1-10 indicates virtually no risk of issues for the enterprise because there is an exceptionally low likelihood of discrimination. In some embodiments, the table may be color coded with high scores highlighted in red and low scores highlighted in green to allow a user to easily identify those values that are of concern versus those that are not indicating an risk that needs immediate attention.

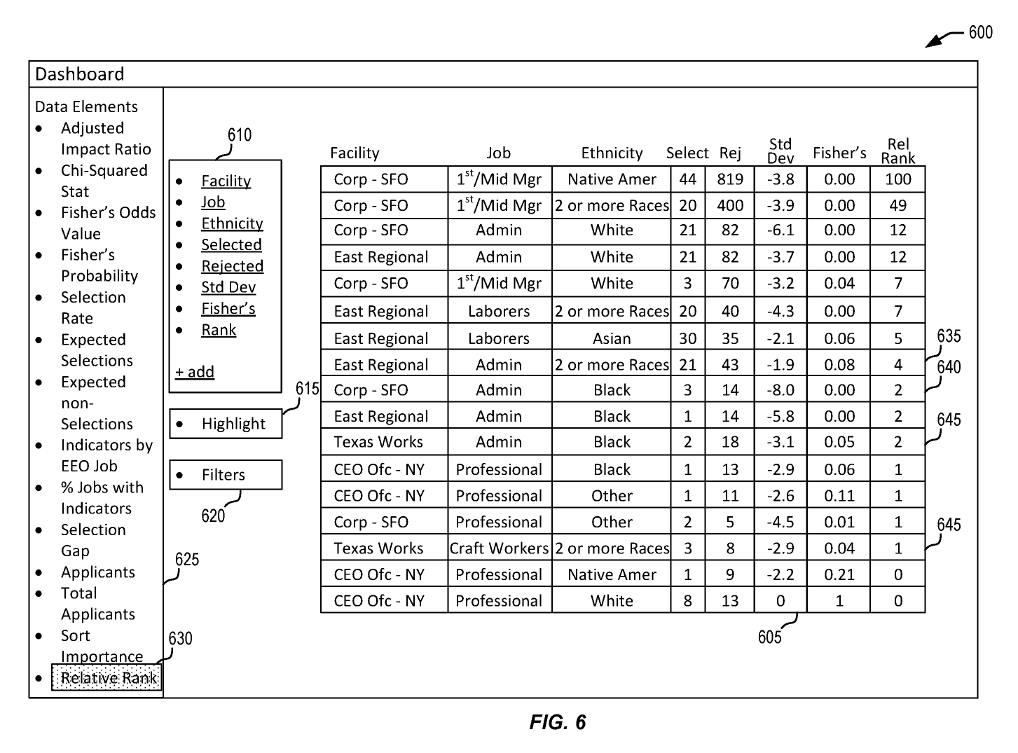

FIG. 6 illustrates another exemplary graphical user interface of a dashboard 600 providing a visual geographical indication of diversity impact data. A user, for example, a human resources officer of the enterprise, may use the dashboard 600 to get an overview of diversity employment information and flagged issues using the dashboard 600. The identified issues and underlying data may be calculated by diversity processing system 120 and provided by GUI subsystem 150.

Dashboard 600 may include a table 605 that provides a listing of information configured however the user may wish to obtain it. Column selection menu 610 allows a user to select the columns to include in table 605. In this case, columns include the facility (e.g., facility name, establishment ID), the EEO job category, the Ethnicity at issue for the diversity aggregate used to create the entry in table 605, the number of selected applicants, the number of rejected applicants, the standard deviation calculated based on the number of selected applicants compared to the number of rejected applicants, the Fisher's probability that the number of selected applicants of the ethnicity would be possible with no discrimination of that ethnicity, and the relative rank of the severity of the issue. Table 605 has been configured to review hiring across the enterprise, making the selected versus rejected candidates relevant information for this table 605.

Dashboard 600 further includes the ability to highlight entries using highlight tool 615. For example, entries in table 605 may be highlighted based on the Fisher's probability number. Note entries are not ranked purely by the Fisher's probability or Standard deviation. Rather, the relative ranking may take into account external information from, for example, the United States Department of Labor that provides statistics on the number of applicants that should be available in any given part of the country. If, for example, the applicant pool of Hispanic people is low in the Midwest, for example at a Chicago, Ill. facility, it may be that the Department of Labor statistics would indicate that the number of Hispanic people in the Midwest is low generally, so a low number of applicants would not necessarily indicate an issue. However, the opposite may be true, which could be used to indicate that there is an issue and increase the relative ranking of any indicators that Hispanic hiring in Chicago is low. Additionally, the total number of affected people may substantially increase the relative ranking, even if the severity of the issue is smaller. For example, the Fisher's probability that an issue with low hiring of administrative staff of 2 or more races in the east regional facility is 0.08 and the standard deviation is −1.9. The relative rank of this indicator is 4 as shown at entry 635. However, the Fisher's probability that an issue with low hiring of administrative staff that are black in the corporate San Francisco office is zero and the standard deviation is −8. Despite this issue having a higher severity (a probability of 8% is much higher that there is no issue than a probability of 0%), the relative rank is lower (i.e., 2) as shown at entry 640. Further, as a standard measure mandated by the EEOC and the United States Department of Labor Office of Federal Contract Compliance Programs (OFCCP), the standard deviation of a protected class (e.g., black, over 40, disabled, veteran) should be no more than 2 standard deviations away from the favored class (e.g., white, under 40, not disabled, non-veteran). The lower ranking of the more egregious issue may be in part because of external data as noted above. Additionally, the number of affected individuals in entry 635 is 64 (21 selected applicants plus 43 rejected applicants), and the number of affected individuals in entry 640 is much smaller with only 17 (3 selected and 14 rejected applicants). Since the number of impacted individuals is less at entry 640, the relative ranking may be lower.

Dashboard 600 may also include selection menu 625 that includes a listing of preconfigured data tables that can be selected to use, such as selection of relative rank 630 as shown. The filtering, selected columns, highlighting, and hierarchical ordering may be preconfigured, and then modified by the column selection box 610, highlighting tool 615, and filtering tool 620. As shown in dashboard 600, when relative rank 630 is selected, the rows are ordered by relative rank.

FIG. 7 illustrates another exemplary graphical user interface of a dashboard 700 providing a visual geographical indication of diversity impact data. A user, for example, a human resources officer of the enterprise, may use the dashboard 700 to get an overview of diversity employment information and flagged issues using the dashboard 700. The identified issues and underlying data may be calculated by diversity processing system 120 and provided by GUI subsystem 150.

Dashboard 700 may provide additional detail for a facility if, for example, a user selects entry 645 of dashboard 600 to drill down to more specific information regarding the associated facility. For example, dashboard 700 includes table 705, which lists all the data columns selected in column selection box 710. A user may configure the data columns included in table 705 using column selection box 710. The example table 705 includes diversity aggregate information for the Texas Works facility for EEO job category Craft workers. In the Texas Works facility, applicants for Craft Worker jobs are divided into ethnicity, and the number of selected candidates and rejected candidates of each ethnicity are listed. The selection rate is calculated along with the standard deviation (using the two-tailed Z-test) from the favored class (in this example, Asian individuals are the favored class). The favored class in any given comparison is the class with the most favorable numbers. In this example, the selection rate of 0.63 for Asian candidates is the highest selection rate, making Asian candidates the favored class. As discussed with respect to FIG. 1, scoring subsystem 140 may also calculate the impact ratio (using the ⅘^{th} rule), the Chi-square value (using, for example, Pearson's Chi-square test), the Fisher's probability (using, for example, a computationally efficient approximation of Fisher's Exact Test), and the diversity impact score.

Dashboard 700 additionally provides graphs for more detail on each calculated value. For example, graph 715 provides a graph of selection rate by ethnicity. As can be seen in table 705 and graph 715, selection rate for Asian candidates is highest, and selection rate for Black candidates is lowest. Graph 720 provides a visual representation of impact ratio by ethnicity. Impact ratio is calculated using the ⅘^{th} rule, and the impact ratio should be no less than 80%. An impact ratio of less than 80% indicates that the EEOC or the OFCCP may find probable cause to investigate the treatment of that protected class further.

Graph 725 provides the standard deviation by ethnicity. The standard deviation is calculated using the two-tailed Z-test. A protected class should be no more than 2 standard deviations from the favored class to not be a candidate for further investigation using EEOC and OFCCP standards. More than 2 standard deviations, under EEOC and OFCCP standards, indicates probable cause for further investigation with the treatment of that protected class. As shown by table 705 and graph 725, Black candidates are more than 4 standard deviations from the favored class of Asian candidates in this example. Native American candidates are also more than 2 standard deviations from Asian candidate, and candidates of 2 or more races are almost 3 standard deviations from Asian candidates.

Graph 730 provides the Chi-square value by ethnicity. The Chi-square value may be calculated using Pearson's Chi-square test. Chi-square values of more than 3.84 indicate a potential issue with the protected class. As shown in table 705 and graph 730, black candidates have a Chi-square value of 8.28.

In some embodiments, table 705 and graphs 715, 720, 725, and 730 may be color coded to highlight the entries that indicate an issue. For example, entry 735 may be highlighted as red in table 705 to indicate that Black candidates show an indication of issue in virtually every category of measure. Entry 740 may be highlighted a lighter shade of red or perhaps orange to indicate that this category of candidate is also facing issues.

The techniques described herein provide various advantages and benefits. The data collection and conversion provides a way to obtain a single, large dataset for analysis. The analysis of the large dataset by generating aggregates for comparison provides substantial processing advantages. The aggregates may be nested, which provides a way to quickly analyze and categorize the aggregates. Further, the aggregates can be analyzed using the statistical models and metrics that are computationally efficient for speed and accuracy. The aggregates may be stored in a single data store rather than generated repeatedly and/or stored in multiple locations based on portions of the data, as would be likely if the collection and conversion to a single data store were not done. Further, the computationally efficient statistical models and metrics used can provide a way for an enterprise to have the necessary analysis quickly and efficiently. The statistical models and metrics may be selected as desired by the enterprise, and using those statistical models and metrics described herein provide the analysis needed for EEOC and United States Department of Labor (DOL) regulations (e.g., the ⅘^{th} rule) and further provide accuracy for business purposes (e.g., a computationally efficient approximation of Fisher's Exact Test).

Previous systems were error prone and manually tedious for analysts, taking months to collect the data, generate the computations needed for DOL EEOC and/or OFCCP regulations, and review them manually. The result from these analyses was merely a long list of location-job category-gender-ethnicity based statistic calculations. The analysts further had to manually analyze thousands of rows of output just to identify a few potential diversity related issues. The described techniques cut the amount of time to generate the statistical measures from months to moments. Further, the described techniques provide data that a user can quickly and easily analyze because it may be provided on a normalized scale, the statistical measures may be combined to create a diversity impact score that is accurate for the given data, and the diversity indicators may be color coded or otherwise prioritized to easily point the user to issues.

The diversity impact scores can be specifically used by users (regardless of the normalized scale used or if the scores are simply provided as high/medium/low risk assessments) to see where diversity issues exist. This can preemptively help the enterprise avoid EEOC sanctions and/or legal action as well as legal action from individuals. By using the EEOC required statistical models and metrics, an enterprise can avoid violating EEOC regulations and stay within the legal regulations. If a user, such as a human resources employee, sees that a diversity indicator suggests that the enterprise is outside of EEOC regulation compliance, modifications to employment practices can be made and training can be provided to, for example, hiring managers, to rectify potential risks and bring the enterprise closer to its diversity goals.

FIG. 8 depicts a simplified diagram of a distributed system 800 for implementing an embodiment. In the illustrated embodiment, distributed system 800 includes one or more client computing devices 802, 804, 806, and 808, coupled to a server 812 via one or more communication networks 810. Clients computing devices 802, 804, 806, and 808 may be configured to execute one or more applications.

In various embodiments, server 812 may be adapted to run one or more services or software applications that enable calculation of diversity impact and analysis, such as diversity processing system 120 of FIG. 1.

In certain embodiments, server 812 may also provide other services or software applications that can include non-virtual and virtual environments. In some embodiments, these services may be offered as web-based or cloud services, such as under a Software as a Service (SaaS) model to the users of client computing devices 802, 804, 806, and/or 808. Users operating client computing devices 802, 804, 806, and/or 808 may in turn utilize one or more client applications to interact with server 812 to utilize the services provided by these components.

In the configuration depicted in FIG. 8, server 812 may include one or more components 818, 820 and 822 that implement the functions performed by server 812. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, and/or 808 to access a graphical user interface to view dashboards such as dashboards 400, 50, 600, and 700 in accordance with the teachings of this disclosure. Such client computing devices 802, 804, 806, and/or 808 may be used for example as user system 110 of FIG. 1. A client device may provide an interface that enables a user of the client device to interact with the client device. The client device may also output information to the user via this interface. Although FIG. 8 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 810 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 810 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 812 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 812 can include one or more virtual machines running virtual operating systems, or other computing architectures involving virtualization such as one or more flexible pools of logical storage devices that can be virtualized to maintain virtual storage devices for the server. In various embodiments, server 812 may be adapted to run one or more services or software applications that provide the functionality described in the foregoing disclosure.

The computing systems in server 812 may run one or more operating systems including any of those discussed above, as well as any commercially available server operating system. Server 812 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 812 may include one or more applications to analyze and consolidate data feeds and/or event updates received from users of client computing devices 802, 804, 806, and 808. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 812 may also include one or more applications to display the data feeds and/or real-time events via one or more display devices of client computing devices 802, 804, 806, and 808.

Distributed system 800 may also include one or more data repositories 814, 816. These data repositories may be used to store data and other information in certain embodiments. For example, one or more of the data repositories 814, 816 may be used to store employee information such as payroll data, employee data, and hiring data as shown in data sources 105 of FIG. 1. Further data repositories 814, 816 may store diversity aggregates and other collected, converted, or calculated data of data processing system 120 as shown in FIG. 1 as diversity impact database 115. Data repositories 814, 816 may reside in a variety of locations. For example, a data repository used by server 812 may be local to server 812 or may be remote from server 812 and in communication with server 812 via a network-based or dedicated connection. Data repositories 814, 816 may be of different types. In certain embodiments, a data repository used by server 812 may be a database, for example, a relational database, such as databases provided by Oracle Corporation® and other vendors. One or more of these databases may be adapted to enable storage, update, and retrieval of data to and from the database in response to SQL-formatted commands.

In certain embodiments, one or more of data repositories 814, 816 may also be used by applications to store application data. The data repositories used by applications may be of different types such as, for example, a key-value store repository, an object store repository, or a general storage repository supported by a file system.

In certain embodiments, the diversity impact processing performed by diversity processing system 120 described in this disclosure may be offered as services via a cloud environment. FIG. 9 is a simplified block diagram of a cloud-based system environment in which various diversity impact processing services may be offered as cloud services, in accordance with certain embodiments. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 812. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other embodiments, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative embodiments.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the customer's own on-premise servers and systems. The cloud service provider's systems are managed by the cloud service provider. Customers can thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, Calif., such as middleware services, database services, Java cloud services, and others.

In certain embodiments, cloud infrastructure system 902 may provide one or more cloud services using different models such as under a Software as a Service (SaaS) model, a Platform as a Service (PaaS) model, an Infrastructure as a Service (IaaS) model, and others, including hybrid service models. Cloud infrastructure system 902 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 902. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 902. Cloud infrastructure system 902 then performs processing to provide the services requested in the customer's subscription order. For example, the diversity dashboards may be provided through the cloud infrastructure system 902 after processing the employee data to develop the diversity aggregates and diversity impact scores. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public customer, where the customer can be an individual or an enterprise. In certain other embodiments, under a private cloud model, cloud infrastructure system 902 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other embodiments, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902. For example, a user may use a client device to request the diversity impact scores or other dashboard graphical user interfaces as described in this disclosure.

In some embodiments, the processing performed by cloud infrastructure system 902 for providing the data collection of employment data and conversion of the employment data to a single format to use for generating the diversity aggregates and performing the other diversity related calculations described herein may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for generating the diversity aggregates, for example, the nested diversity aggregates described. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain embodiments, to facilitate efficient provisioning of these resources for supporting the various cloud services provided by cloud infrastructure system 902 for different customers, the resources may be bundled into sets of resources or resource modules (also referred to as “pods”). Each resource module or pod may comprise a pre-integrated and optimized combination of resources of one or more types. In certain embodiments, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users or customers of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a customer may, using a client device, request (service request 934) one or more services provided by cloud infrastructure system 902 using one or more of interfaces 914, 916, and 918. For example, a customer may access the online store, browse cloud services offered by cloud infrastructure system 902, and place a subscription order for one or more services offered by cloud infrastructure system 902 that the customer wishes to subscribe to. The service request may include information identifying the customer and one or more services that the customer desires to subscribe to. For example, a customer may place a subscription order for a diversity analysis related service offered by cloud infrastructure system 902. As part of the order, the customer may provide information identifying the enterprise data sources from which to collect the data to aggregate and use for analysis.

In certain embodiments, such as the embodiment depicted in FIG. 9, cloud infrastructure system 902 may comprise an order management subsystem (OMS) 920 that is configured to process the new order. As part of this processing, OMS 920 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 920 may then invoke the order provisioning subsystem (OPS) 924 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

Cloud infrastructure system 902 may send a response or notification 944 to the requesting customer to indicate when the requested service is now ready for use. In some instances, information (e.g., a link) may be sent to the customer that enables the customer to start using and availing the benefits of the requested services.

Cloud infrastructure system 902 may provide services to multiple customers. For each customer, cloud infrastructure system 902 is responsible for managing information related to one or more subscription orders received from the customer, maintaining customer data related to the orders, and providing the requested services to the customer. Cloud infrastructure system 902 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 902 may provide services to multiple customers in parallel. Cloud infrastructure system 902 may store information for these customers, including possibly proprietary information. In certain embodiments, cloud infrastructure system 902 comprises an identity management subsystem (IMS) 928 that is configured to manage customers information and provide the separation of the managed information such that information related to one customer is not accessible by another customer. IMS 928 may be configured to provide various security-related services such as identity services, such as information access management, authentication and authorization services, services for managing customer identities and roles and related capabilities, and the like.

FIG. 10 illustrates an exemplary computer system 1000 that may be used to implement certain embodiments. For example, in some embodiments, computer system 1000 may be used to implement any of the diversity processing system 120, user system 110, and various servers and computer systems described above. As shown in FIG. 10, computer system 1000 includes various subsystems including a processing subsystem 1004 that communicates with a number of other subsystems via a bus subsystem 1002. These other subsystems may include a processing acceleration unit 1006, an 1/O subsystem 1008, a storage subsystem 1018, and a communications subsystem 1024. Storage subsystem 1018 may include non-transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may include be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some embodiments, processing subsystem 1004 can include one or more special purpose co-processors such as graphics processors, digital signal processors (DSPs), or the like. In some embodiments, some or all of the processing units of processing subsystem 1004 can be implemented using customized circuits, such as application specific integrated circuits (ASICs), or field programmable gate arrays (FPGAs).

In some embodiments, the processing units in processing subsystem 1004 can execute instructions stored in system memory 1010 or on computer readable storage media 1022. In various embodiments, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain embodiments, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some embodiments. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 1022 may store programming and data constructs that provide the functionality of some embodiments. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, DVD, a Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 1018 may also include a computer-readable storage media reader 1020 that can further be connected to computer-readable storage media 1022. Reader 1020 may receive and be configured to read data from a memory device such as a disk, a flash drive, etc.

In certain embodiments, computer system 1000 may support virtualization technologies, including but not limited to virtualization of processing and memory resources. For example, computer system 1000 may provide support for executing one or more virtual machines. In certain embodiments, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communication subsystem may be used to establish a communication channel between diversity processing system 120 and data sources 105, diversity impact database 115, and/or user systems 110.

Communication subsystem 1024 may support both wired and/or wireless communication protocols. For example, in certain embodiments, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

Communication subsystem 1024 can receive and transmit data in various forms. For example, in some embodiments, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain embodiments, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art will appreciate other ways and/or methods to implement the various embodiments.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method for monitoring diversity impact, the method comprising:
receiving, by a data processing system, employment information for an enterprise from a plurality of data sources, the employment information comprising employee data for employees of the enterprise;
generating, by the data processing system, a plurality of aggregates of the employment information based on a plurality of classifications;
identifying, by the data processing system, a first aggregate of the plurality of aggregates for analysis;
identifying, by the data processing system, a second aggregate of the plurality of aggregates, the second aggregate being related to the first aggregate for identifying an impact score;
generating, by the data processing system, a plurality of statistical scores for the first aggregate as compared to the second aggregate, wherein each statistical score of the plurality of statistical scores is based on one of a plurality of statistical models;
assigning, by the data processing system, a weight to each of the plurality of statistical scores to generate a plurality of weighted statistical scores, wherein the weighting each of the plurality of statistical scores is based at least in part on attributes of the employment information used to generate the first aggregate and the second aggregate and based at least in part on a value of each of the statistical scores;
computing, by the data processing system, the impact score for the first aggregate as compared to the second aggregate by combining the plurality of weighted statistical scores; and
transmitting, by the data processing system, the impact score to a user device for output by the user device.

2. The method for monitoring diversity impact of claim 1, wherein the assigning a weight to each of the plurality of statistical scores to generate a plurality of weighted statistical scores comprises:
identifying a size of a data set of the employment information used to generate the first aggregate and the second aggregate; and
setting the assigned weight for at least one of the plurality of statistical scores based on an accuracy of the statistical model used to generate the statistical score for the size of the data set.

3. The method for monitoring diversity impact of claim 1, wherein the computing the impact score comprises:
performing a linear regression or a continuous predictor machine learning technique to combine the plurality of weighted statistical scores.

4. The method for monitoring diversity impact of claim 1, wherein the plurality of statistical models comprise at least one of Pearson's Chi-Square Test, Two-Tailed Z-Test, and Fisher's Exact Test.

5. The method for monitoring diversity impact of claim 1, wherein the plurality of classifications comprise at least one of gender, ethnicity, veteran status, disability status, and age.

6. The method for monitoring diversity impact of claim 1, wherein each of the plurality of aggregates provides an aggregate value based on individuals of a diversity classification aggregated over a period of time by an employment data type.

7. The method for monitoring diversity impact of claim 6, wherein the employment data type is one of hiring, termination, promotion, and salary.

8. The method for monitoring diversity impact of claim 1, wherein the plurality of aggregates comprise nested aggregates, and wherein the nested aggregates are nested based on at least one of geographical location, job category, and enterprise facility.

9. The method for monitoring diversity impact of claim 1, the method further comprising:
in response to receiving the employment information of the enterprise from the plurality of data sources:
convert the employment information from each of the plurality of data sources to a single format; and
store the converted employment information in a diversity impact data store; and
wherein the plurality of aggregates are generated from the converted employment information.

10. The method for monitoring diversity impact of claim 1, wherein the employment information comprises at least one of enterprise hiring data, enterprise termination data, enterprise compensation data, and enterprise promotion data.

11. The method for monitoring diversity impact of claim 1, wherein the employee data for employees of the enterprise comprises, for each employee, at least one of gender, ethnicity, veteran status, disability status, and age.

12. The method for monitoring diversity impact of claim 1, wherein transmitting the impact score to the user device comprises:
determining that the impact score exceeds a threshold value; and
transmitting an alert to the user device comprising a natural language message that includes the impact score.

13. The method for monitoring diversity impact of claim 1, wherein the transmitting the impact score to the user device comprises:
generating a graphical user interface comprising an image of a geographical region with an indicator of the impact score, wherein clicking on the indicator provides drill-down capabilities that expose the first aggregate, the second aggregate, and the employment information used to generate the first aggregate and the second aggregate.

14. The method for monitoring diversity impact of claim 1, further comprising:
generating, by the data processing system, a plurality of impact scores, wherein each impact score of the plurality of impact scores is based on one of the plurality of aggregates; and
ranking, by the data processing system, each of the plurality of impact scores based at least in part on a size of a data set of the employment information used to generate the aggregate on which the impact score is based.

15. The method for monitoring diversity impact of claim 1, further comprising:
generating, by the data processing system, a plurality of impact scores, wherein each impact score of the plurality of impact scores is based on one of the plurality of aggregates; and
ranking, by the data processing system, each of the plurality of impact scores based at least in part on statistics from an external source.

16. The method for monitoring diversity impact of claim 15, wherein the external source is the United States Department of Labor.

17. A system for monitoring diversity impact, the system comprising:
one or more processors; and
a memory having stored thereon instructions that, when executed by the one or more processors, cause the one or more processors to:
receive employment information for an enterprise from a plurality of data sources, the employment information comprising employee data for employees of the enterprise;
generate a plurality of aggregates of the employment information based on a plurality of classifications;
identify a first aggregate of the plurality of aggregates for analysis;
identify a second aggregate of the plurality of aggregates, the second aggregate being related to the first aggregate for identifying an impact score;
generate a plurality of statistical scores for the first aggregate as compared to the second aggregate, wherein each statistical score of the plurality of statistical scores is based on one of a plurality of statistical models;
assign a weight to each of the plurality of statistical scores to generate a plurality of weighted statistical scores, wherein the weighting each of the plurality of statistical scores is based at least in part on attributes of the employment information used to generate the first aggregate and the second aggregate and based at least in part on a value of each of the statistical scores;
compute the impact score for the first aggregate as compared to the second aggregate by combining the plurality of weighted statistical scores; and
transmit the impact score to a user device for output by the user device.

18. The system for monitoring diversity impact of claim 17, wherein the instructions for assigning a weight to each of the plurality of statistical scores to generate a plurality of weighted statistical scores comprises instructions that, when executed by the one or more processors, cause the one or more processors to:
identify a size of a data set of the employment information used to generate the first aggregate and the second aggregate; and
set the assigned weight for at least one of the plurality of statistical scores based on an accuracy of the statistical model used to generate the statistical score for the size of the data set.

19. A system for monitoring diversity impact, the system comprising:
one or more processors; and
a memory having stored thereon instructions that, when executed by the one or more processors, cause the one or more processors to:
provide a graphical user interface to a user comprising a selection menu;
receive, from the graphical user interface, a selection of a classification, a time frame, and an employment data type;
obtain first employment data having the selected classification, the selected time frame, and the selected employment data type;
identify a comparable classification to the selected classification;
obtain second employment data having the comparable classification, the selected time frame, and the selected employment data type;
generate a plurality of statistical scores for the first employment data compared to the second employment data using a plurality of statistical models;
calculate an impact score based on the plurality of statistical scores;
generate an indicator based on the impact score; and
provide, via the graphical user interface, the indicator.

20. The system for monitoring diversity impact of claim 19, wherein providing the indicator comprises:
generating a graphical image of a geographical location related to the indicator; and
displaying the indicator on the graphical image of the geographical location in the graphical user interface.
